(19) United States
(12) Patent Application Publication
(10) Pub. No.: US 2024/0421547 A1
(43) Pub. Date: Dec. 19, 2024

(54) SUPPORT PROFILE RAIL ELEMENT WITH CONNECTION TERMINAL

(71) Applicant: Zumtobel Lighting GmbH, Dornbirn (AT)

(72) Inventor: Gerald Ladstätter, Dornbirn (AT)

(73) Assignee: Zumtobel Lighting GmbH, Dornbirn (AT)

(21) Appl. No.: 18/706,412

(22) PCT Filed: Dec. 22, 2022
(86) PCT No.: PCT/EP2022/087484

§ 371 Date: May 1, 2024

(30) Foreign Application Priority Data
Dec. 28, 2021 (DE) 10 2021 006 454.2

(51) Int. Cl. H01R 25/14

(52) U.S. Cl. CPC H01R 25/145

(57) ABSTRACT

The invention relates to a support profile rail element (1) comprising a longitudinal profile rail element (2) and a connection terminal (3). The connection terminal (3) has an insulating material housing (5) and a plurality of spring force clamping connections (6). Each of the spring force clamping connections has: a first conductor clamping point (61) for directly mechanically and electrically coupling at least one electric conductor (103) in a first conductor connection direction (L1) and a second conductor clamping point (62-64) which is electrically connected to the first conductor clamping point (61) of the same force clamping connection (6) in order to directly mechanically and electrically couple at least one external electric conductor for electrically connecting the support profile rail element (1).

### CROSS-REFERENCE TO RELATED APPLICATION

The present application is the U.S. national stage application of international application PCT/EP2022/087484 filed Dec. 22, 2022, which international application was published on Jul. 6, 2023 as International Publication WO 2023/126306 A1. The international application claims priority to German Patent Application No. 10 2021 006 454.2, filed Dec. 28, 2021.

### TECHNICAL FIELD OF THE INVENTION

The present invention relates to a support profile rail element for forming an elongated support rail system with an elongated profile rail element and a connection terminal arranged therein. The invention also relates to a corresponding support rail system. The present invention also relates to a connection device for such a support rail system with a carrier and a connection terminal secured thereto.

### BACKGROUND OF THE INVENTION

Elongated support rail systems are known in principle. For example, such a support rail system is offered by the applicant under the designation TECTON. Such support rail systems generally have elongated profile rail elements which can be assembled lengthwise in series to form an overall system of any length. The individual profile rail elements thereby generally form or surround a common elongated interior. In the interior, a busbar extends longitudinally. Electrical or electronic components can be mounted on the profile rail elements—preferably at any point along the longitudinal extension of the support rail system—in such a way that they can be electrically coupled to the busbar and can thus be connected to the power grid and/or data network provided via the busbar, and operated. In order to mechanically connect the individual profile rail elements to one another, connectors can be used which generally each extend across adjacent profile rail elements in the interior and are mechanically connected thereto in such a way that the profile rail elements are fixed in position relative to one another.

Special profile rail modules in which corresponding electrical coupling is provided are often offered for feeding into or for feeding out of the support rail system. This electrical coupling has an individually provided plug that can be connected to the busbar. The contacts of this plug are electrically connected via individual wires to connection blocks distributed longitudinally in the profile rail element. This requires each individual electrical conductor of the busbar to be individually electrically connected to a corresponding connection block via individual wires. This requires a corresponding amount of space for cabling. In addition, the distributed arrangement of the connection blocks in the profile rail element also requires a profile rail of corresponding length such that such feed-in or feed-out modules are comparatively spacious. These feed modules can usually be provided as end modules at the end of a support rail system or at a flexible transition between two support rail systems. It is also conceivable that the feed modules are provided as central feed modules between two corresponding profile rail elements of a support rail system.

### SUMMARY OF THE INVENTION

It is now an object of the present invention to provide a support profile rail element for forming an elongated support rail system, such a support rail system and also a connection device for such a support rail system, which enable simple electrical coupling of a feed-in or feed-out to a busbar of a support rail system with a small number of parts and low degree of complexity.

This object is achieved by the subject matter of the independent claims. The dependent claims develop the central idea of the present invention in a particularly advantageous manner.

According to a first aspect, the present invention relates to a support profile rail element (for example, a luminaire support profile rail element) for forming an elongated support rail system (for example, a luminaire support rail system). This elongated support rail system has an elongated busbar arranged in a system interior of the support rail system and extending longitudinally therein, which busbar comprises electrical conductors extending longitudinally in parallel with one another for the electrical connection of electrical or electronic components via an elongated system coupling opening of the support rail system.

The support profile rail element itself has an elongated profile rail element with a longitudinal extension. The elongated profile rail element delimits an interior and has an elongated coupling opening. At at least one of its ends opposite one another in relation to the longitudinal extension, the profile rail element has a connection section for connecting to a corresponding further connection section of an elongated support profile rail in order to form an elongated support rail system. Consequently, the support profile rail element—or its profile rail element—can be arranged longitudinally in series with at least one or more profile rail elements via this connection section and can be connected thereto form the support rail system.

On the other hand, the support profile rail element has a connection terminal, which is completely accommodated and secured in the interior. The connection terminal has an insulating material housing on the one hand. On the other hand, the connection terminal also has a plurality of spring force clamping connections, all of which are at least partially or completely accommodated in the insulating material housing.

Within the framework of the present invention, “completely accommodated (in the interior)” is preferably understood to mean that the corresponding component (here, for example, the connection terminal) is completely accommodated within the outer contour of the corresponding reference space (here, for example, the interior): consequently, it does not protrude outward beyond it.

Each of the spring force clamping connections in turn has a first conductor clamping point in order to directly mechanically and electrically couple at least one electrical conductor (in particular an electrical conductor of a busbar described above) in a first conductor connection direction. Each spring force clamping connection also has a second conductor clamping point, which is electrically connected to the first conductor clamping point of the same spring force clamping connection. The second conductor clamping point is used for directly mechanically and electrically coupling at least one external electrical conductor (i.e., for example, an electrical conductor for feed-in or feed-out) in a second conductor connection direction for electrically connecting the support profile rail element.

Within the framework of the present invention, “direct electrical and mechanical coupling” is understood to mean both a direct electrical connection and a direct physical connection (i.e., without further intermediate elements, such as wires, cables or other connection blocks) between the components described.

All of the first conductor connection directions are parallel to one another. The connection terminal is arranged relative to the connection section such that, when the support profile rail element is connected to a support profile rail, which has an elongated busbar extending longitudinally therein (i.e.: (upon a connection) to a support profile rail that has an elongated busbar extending longitudinally therein) via its (i.e.: of the support profile rail) further connection section, all of the likewise parallel electric conductors of the corresponding busbar, for example, are simultaneously directly mechanically and electrically coupled to the respective first conductor clamping points during a coupling movement of the support profile rail element or at least of the connection terminal secured in the interior, which movement is parallel to the first conductor connection directions.

The support profile rail element according to the invention provides a module that enables feed-in or feed-out in a support rail system in a simple manner. Thus, the second conductor clamping points are all provided in a manner bundled together in the single connection terminal, and can therefore be easily reached and arranged to save space. On the other hand, the bundled provision of the first conductor clamping points in a connection terminal enables the single connection terminal provided for connecting external conductors to be directly coupled electrically and mechanically to the busbar by means of a simple coupling movement—such as a translational plug-in movement. Thus, the previous connection of individual electrical conductors is no longer necessary. Furthermore, instead of an individually provided and designed plug and also numerous connection blocks, a single element, possibly equipped with known and further preferred standardized components, can be provided per busbar, which significantly reduces both production costs and complexity and assembly effort. Since the connection terminal is also completely accommodated in the interior of the elongated profile rail element—thus lying completely within the outer contour of the profile rail element—the support profile rail element can be designed to be as compact as possible, regardless of the electrical feed-in or feed-out. The feed-in and feed-out components do not impair the external aesthetic appearance of the support rail system or its support profile rail element either.

The support profile rail element can preferably have at least two connection terminals, which can preferably be distributed over the two opposite sides in relation to the coupling opening and/or a side opposite the coupling opening (consequently, for example, a rear side of the profile rail element). Thus, the connection terminals can be arranged according to a busbar configuration arranged in the support rail system to be formed. On the other hand, the connection terminals are then provided in such a way that they block the coupling opening as little as possible or not at all and thus a large region of the support profile rail element or a support rail system to be formed therewith along a corresponding system coupling opening can be used for other purposes—such as for accommodating electrical or electronic components or for their electrical coupling.

The connection terminal(s) is/are preferably releasably secured. Thus, the flexibility of the support profile rail element can be increased and, as a result, the overall flexibility often required of a corresponding support rail system can be further increased.

The first conductor clamping points are preferably each designed for the selective, preferably tool-free, connection and release of electrical conductors. Thus, the first conductor clamping points can preferably not only be simply connected to a corresponding busbar by movement in a coupling motion, as already described, but also release of the first conductor clamping points can be enabled in a simple manner if required. This is particularly preferably possible without tools, which further increases ease of use. In addition, flexible conductors can thus also be simply connected if required.

In a similar way, the second conductor clamping points can also each be designed for the selective, preferably tool-free, connection and release of electrical conductors. Thus, external conductors for feeding in or feeding out can also be connected not only in a simple manner, but can optionally also be released again so that the flexibility of a support rail system formed with the support profile rail element is further increased. Since this connection and release can also be enabled without tools, the overall ease of use is further increased. In addition, flexible conductors can thus also be simply connected here if required.

Each spring force clamping connection can have a contact element along with at least one clamping spring with at least one movable clamping leg. The clamping leg can be movable between a clamping position, in which the clamping leg presses against a contact portion of the contact element to form the first or second conductor clamping point, and an insertion position, in which this conductor clamping point is open for the insertion of an electrical conductor. Consequently, a corresponding design can be used both in the formation of the first conductor clamping point and (additionally or alternatively) in the formation of the second conductor clamping point. Thus, an effective spring force clamping connection can be provided in a particularly simple manner, which is particularly easy to use.

Each of the spring force clamping connections can have at least one release element for the selective tool-free opening of at least one of the conductor clamping points. In this manner, the ease of use for connecting or releasing any conductors can be significantly increased. Incorrect operation and incorrect assignment of the corresponding conductor clamping point can also be prevented. The release element can preferably have a pusher or a swivel lever, which are further preferably movably mounted in the insulating material housing. Thus, an overall easy-to-use release element can be provided, which is also secure-since it is insulated and simply mounted. The release element in the form of a pusher is easy to produce and requires only a few components with an overall simple structure. The release element in the form of a swivel lever enables convenient and safe operation, wherein preferably a plurality of clamping points can be simultaneously opened in a simple manner by just one operator or optionally remain open for the purpose of connecting or releasing electrical conductors.

The release element can preferably interact with the clamping leg in such a way as to selectively move the clamping leg from the clamping position to the insertion position. Consequently, the release element can interact in a simple manner with the aforementioned clamping spring of the spring force clamping connection, thus providing a particularly compact and easy-to-use conductor clamping point on the whole.

Each spring force clamping connection can preferably have a plurality of second conductor clamping points, which are electrically connected to one another and to the first conductor clamping point of the same spring force clamping connection. In this manner, it is possible to either connect a plurality of external conductors for each pole at the feed-in or feed-out point, or to facilitate the connection from different sides of the connection terminal for external electrical conductors on account of the different orientation of the respective second conductor clamping points.

The first conductor connection directions are preferably all parallel to the longitudinal extension. Thus, a coupling movement that is also effected along the longitudinal extension can be carried out in a simple manner in order to enable a connection of the support profile rail element to a busbar of another profile rail element in a simple and space-saving manner.

It is particularly preferred that all of the first conductor connection directions are arranged in a row next to one another. This in turn ensures a particularly compact design of the connection terminal such that the connection terminal occupies as little space as possible in the interior of the profile rail element, thus leaving space for other components along with the connection of external electrical conductors. The connection terminal can thus also be adapted in a simple manner to standard busbar configurations.

All second conductor connection directions can also be parallel to one another and preferably also parallel to the longitudinal extension. All of this ensures a further simplification of the structure of the connection terminal and the intuitive connection of any conductors thereto.

The second conductor connection directions are preferably arranged next to one another in at least one or more rows. A single-row arrangement of the second conductor connection directions is particularly advantageous if there is only one second conductor clamping point, in order to provide a connection terminal that is as compact as possible. If, for example, there are a plurality of second conductor clamping points for each spring force clamping connection, these can each be divided into groups with the same orientation such that second conductor connection directions of a group of second conductor clamping points are always arranged next to one another in rows such that these can be operated in the same manner and with the same orientation and thus intuitively, and are also compact.

For each spring force clamping connection, the first conductor connection direction and the or one of the second conductor connection directions can be aligned coaxially with one another and preferably directed toward one another. This ensures a particularly simple and flat structure of a corresponding connection terminal, which can also be simply and intuitively electrically connected.

For each spring force clamping connection, the first conductor connection direction and the or one of the second conductor connection directions can be radially offset from one another. This is particularly advantageous if there is a plurality of second conductor clamping points for each spring force clamping connection and, for example, one of the second conductor clamping points should be accessible from the same side of the connection terminal as the first conductor clamping point of the same spring force clamping connection. In this manner, a sensible compromise is made between a compact design on the one hand and a high degree of user-friendliness on the other hand.

The first conductor connection direction and the or one of the second conductor connection directions are particularly preferably radially offset from one another in such a way that the first conductor clamping point is closer to the profile rail element than the second conductor clamping point assigned to the second conductor connection direction when the connection terminal is secured in the interior. In this manner, the first conductor clamping point can be provided as close as possible to the profile rail element, as a result of which it is provided in a position in which a busbar to be connected thereto is generally also arranged, specifically saving as much space as possible on an inner wall of the profile rail element. In addition, the second conductor clamping point—preferably accessible on the same side as the first conductor clamping point—is then still easily accessible even when the busbar is electrically connected to the first conductor clamping point such that a support rail system equipped therewith offers a high degree of user-friendliness and flexibility.

For each spring force clamping connection, the first conductor clamping point and the or at least one of the second conductor clamping points can be accessible from opposite sides of the connection terminal. This corresponds to a configuration that is currently often used, according to which the busbar can be connected on one side and an electrical feed-in or feed-out on the opposite side. In addition, the connection terminal can thus be compact overall. Furthermore, confusion between first and second conductor clamping points can be reliably avoided. In addition, due to the spatial separation of the first and second conductor clamping points, an electrical connection of external electrical conductors to the second conductor clamping points can be effected in a very simple manner, even when the busbar is connected to the first conductor clamping points.

The insulating material housing can have one conductor insertion channel for each conductor clamping point, which channel extends from the outside toward the assigned conductor clamping point and preferably tapers, at least in portions, toward the conductor clamping point. On the one hand, the insertion of electrical conductors toward the conductor clamping points can thus be simplified. Furthermore, the conductor clamping points are safely against access by a user due to the insulating material of the insulating material housing.

The profile rail element can be produced from sheet metal. For example, the profile rail element can be produced as a stamped and bent part. Thus, the profile rail element can be provided in a simple manner and in accordance with requirements.

The support profile rail element can also have a carrier that supports the connection terminal or the plurality of connection terminals. The connection terminal(s) can preferably be releasably or non-releasably connected to the carrier. Due to the provision of the connection terminal by means of a carrier, the provision of the connection terminal in the interior of the profile rail element can be simplified, since the carrier can be adapted to connecting regions of the profile rail element, for example, while a standard component can be used for the connection terminal, for example. Moreover, by means of the carrier, based on a material selection desired for this purpose, a highly mechanically stable, secure and electrically preferred connection to the profile rail element can be enabled. In addition, the connection terminal can be positioned in the interior in a simple, defined manner, which in turn minimizes assembly errors.

The carrier can have first coupling sections that are designed to interact with second coupling sections of the profile rail element for securing the carrier together with the connection terminal or connection terminals in the interior. In this manner, the carrier can be easily and simply connected to the profile rail element.

The carrier can have a substantially U-shaped cross-section such that it has a high degree of stability. For example, this shape can also be used as a kind of spring, wherein the side legs of the carrier can be elastically compressed, for example, in order to insert the carrier into the profile rail element so as to be securely arranged in the profile rail element by returning it to its original shape.

In a particularly preferred design, the carrier can have a cross-sectional contour that follows a cross-sectional contour of the profile rail element, at least in portions. Thus, when inserted in the profile rail element, the carrier preferably lies partially surface-to-surface against the profile rail element, which enables secure positioning on the one hand and a secure electrical connection on the other hand—for example for the purpose of a ground connection.

In particular, the carrier can be produced from an electrically conductive material, for example from sheet metal and/or as a stamped and bent part. This enables a corresponding electrical connection, for example to the profile rail element for grounding purposes. A carrier provided in this way is also easy to produce and also has a high degree of stability and preferably low weight.

The carrier is preferably releasably or non-releasably connected to the profile rail element. This connection can be effected, for example, by means of a force fit, such as by clamping or the like. The connection can also be effected by means of a form fit, such as by snapping or clinching or riveting or screwing or the like. The connection can also be effected by means of an integral bond, such as by welding or soldering or the like. Thus, depending on the requirements, any connection of the carrier and thus the connection terminal(s) to or in the profile rail element can be enabled, which enables a high degree of flexibility to achieve numerous application options.

The connection terminal can preferably have a grounding contact, which is provided in such a way that the grounding contact is electrically connected to the profile rail element when the connection terminal is secured in the interior. In this manner, the support profile rail element can be provided particularly securely. If the connection terminal is provided on a carrier of the type described above, the electrical connection via the grounding contact described above can alternatively also be effected via the carrier. Due to its comparatively high degree of dimensional stability, the carrier provides particularly secure contacting of the grounding contact, at least in the installed state. Through the provision of a corresponding grounding contact, grounding can also be established in a particularly simple and preferably automatic manner upon insertion, which in turn avoids assembly errors and thus increases overall safety.

The insulating material housing preferably has securing structures, which are designed to interact with corresponding securing structures of the profile rail element and/or, if present, with corresponding securing structures of the carrier for securing the connection terminal thereto. In this manner, the connection terminal can be secured in a simple manner. The securing structures can preferably be releasable. Furthermore, the securing structures preferably interact by means of a force fit and further preferably by means of a form fit (for example in the form of a snap-in connection). Thus, the provision of the connection terminal can be enabled particularly simply and flexibly.

The profile rail element can, for example, be a support profile rail itself. The profile rail element can also be a connector for connecting a plurality of support profile rails. Furthermore, the profile rail element can also be a combination of a support profile rail and connector for coupling a further support profile rail to the same support profile rail. The support profile rail and the connector preferably collectively form the interior. Thus, the support profile rail element can be used for coupling with unlimited flexibility and thus for feeding in or feeding out. For example, if the profile rail element is purely a support profile rail, it can be used as the end piece of a support rail system for feed-in, for example. If the profile rail element is a combination of a support profile rail and connector, the connector can be directly included and this unit can thus be connected directly—for example to one end of a support rail system—as a feed-out. The space of a connector can thus also be used accordingly such that the support profile rail of such a combination can be shortened accordingly. If the profile rail element is a connector, for example, feed-in or feed-out can be provided in a particularly compact manner via the connection terminal carried in this way at any joint between corresponding support profile rails in the support rail system. The same naturally also applies to the two other variants described above, which can also be sandwiched between corresponding support profile rails in order to provide a corresponding feed-in or feed-out in this region: although this is done in a less compact way, there is more free space for assembly and other components, for example.

The profile rail element can have a substantially U-shaped cross section when viewed in the direction of longitudinal extension. On the one hand, this enables secure lateral framing of the interior. On the other hand, a corresponding coupling opening can be provided simply-specifically via the open side of the “U”. The profile rail element also has a particularly stable shape.

The profile rail element can have two side wall legs that are substantially parallel and laterally delimit the coupling opening. Thus, a simple structure is enabled. In addition, since the side wall legs delimit the coupling opening, a corresponding busbar or the connection terminals to be coupled thereto for feed-in or feed-out, for example, can be optimized accordingly and simply positioned in this report.

The profile rail element preferably also has a transverse wall leg connecting the side wall legs such that an overall stable and preferably simple structure of the profile rail element is provided.

The connection terminal or connection terminals is/are preferably secured adjacent to one of the two side wall legs and/or the transverse wall legs, if present. In this manner, the connection terminal can be provided in a manner saving as much space as possible so that the interior can be kept free for the most flexible electrical connection options possible. The connection terminal or connection terminals can then be accordingly secured to the corresponding leg (i.e., at least one of the two side wall legs and/or the transverse wall leg) and further preferably by means of the carrier, if present.

According to a further aspect, the present invention further relates to an (elongated) support rail system (for example, a luminaire support rail system), which has at least one support profile rail element according to the present invention. In this regard, reference is also made to the previous description. Furthermore, the support rail system has at least one (elongated) support profile rail with a further longitudinal extension. The further longitudinal extension preferably extends in parallel with or coaxially with the longitudinal extension of the support profile rail element. The support profile rail delimits a further interior and also has a further elongated coupling opening. At at least one of its ends opposite one another with respect to the further longitudinal extension, the support profile rail has a further connection section for connecting to the connection section of the profile rail element to form the support rail system, in such a way that their interiors form a common system interior and their coupling openings form a common system coupling opening.

Furthermore, the support rail system preferably has an elongated busbar that extends longitudinally in the system interior. The busbar has electrical conductors extending longitudinally in parallel with one another (i.e., preferably parallel to the longitudinal extension or further longitudinal extension) for the electrical connection of electrical or electronic components via the system coupling opening. Each of the electrical conductors of the busbar is preferably directly mechanically and electrically coupled on the end face to one of the first conductor clamping points of the connection terminal through a coupling movement of the connection terminal relative to the busbar, which movement is parallel to the first conductor connection directions.

As a result, with the support profile rail element, a support rail system with a corresponding feed-in or feed-out can be provided in a simple and intuitive way and with particularly low assembly effort. The advantages also arise in the same manner as already described above in accordance with the support profile rail element.

The support profile rail element can preferably be designed as an end piece of the support rail system or a center piece for insertion between two further support profile rails, as described above. As described, the support profile rail element can be a profile rail element in the form of a support profile rail, in the form of a connector, or in the form of a combination of a support profile rail and connector. Thus, the support rail system can be formed with maximum flexibility, and a feed-in or feed-out can be provided as required at any point on the support rail system when viewed in the direction of its longitudinal extension.

The busbar is preferably arranged on an inner wall of the support profile rail and/or the profile rail element. Thus, a particularly space-saving arrangement of the busbar can be enabled such that the system coupling opening and the system interior can be used with maximum flexibility, in particular for connecting electrical or electronic components via the system coupling opening.

The support rail system can further have an electrical or electronic component. This electrical or electronic component in turn preferably has a functional section on the one hand and a connection section electrically connected to the functional section for electrical connection to the busbar via the system coupling opening on the other hand. Thus, the support rail system can be fitted with any electrical or electronic components, optionally along its entire longitudinal extension, in order to thus form a continuous strip light system, for example.

For example, the electrical or electronic component can have a luminaire (such as a strip light or a spot light or the like), a sensor (such as a presence sensor or the like), a loudspeaker or the like. Thus, the support rail system can have maximum flexibility in terms of what it may be fitted with, which increases the overall flexibility of the support rail system.

According to a further aspect, the present invention further relates to a connection device for a support rail system—for example a (luminaire) support rail system of the type described above. The support rail system can have an elongated busbar arranged in a system interior of the support rail system and extending longitudinally therein, which busbar comprises electrical conductors extending longitudinally in parallel with one another for the electrical connection of electrical or electronic components via an elongated system coupling opening of the support rail system, as also already described above by way of example. On the one hand, the connection device has a carrier that is designed in such a way that it can be completely inserted into the system interior of the support rail system via the system coupling opening and secured therein. The connection device also has a connection terminal. The connection terminal in turn has an insulating material housing and a plurality of spring force clamping connections. The spring force clamping connections are each at least partially or completely accommodated in the insulating material housing.

Each spring force clamping connection has a first conductor clamping point for direct mechanical and electrical coupling of at least one electrical conductor (for example, an electrical conductor of a busbar) in a first conductor connection direction. Each spring force clamping connection also has a second conductor clamping point, which is electrically connected to the first conductor clamping point of the same spring force clamping connection. The second conductor clamping point is used for directly mechanically and electrically coupling at least one external electrical conductor in a second conductor connection direction for the electrical connection of the connection device. All of the first conductor connection directions are parallel to one another in order to simultaneously directly mechanically and electrically couple all electrical conductors that are also parallel to one another, for example of a corresponding busbar, to the respective first conductor clamping points during a coupling movement that is parallel to the first conductor connection directions. The connection terminal is secured to the carrier in such a way that it can be handled as one unit.

With the connection device described above, a unit is provided with which a connection terminal can be provided in a simple manner as an accessory for a support rail system in any desired manner. In addition, it can be handled in a simple manner. Since the connection terminal is already secured to the carrier accordingly, the connection terminal can thus also be positioned in a defined manner in a corresponding profile rail element. This in turn increases both ease of assembly and assembly safety. Thus, an electrical connection option can be provided for a busbar in a simple manner. The first conductor clamping points are used for simple electrical and mechanical connection of the busbar or its electrical conductors. The second conductor clamping points are used for a simple connection of a feed-in or feed-out or further feeding to a further support rail system.

The combination of a carrier and connection terminal preferably results in the manner already described above, with the advantages also described above, and can, as described, also form an independent part of the present invention. In this respect, reference is also made to the above description with regard to the corresponding features and advantages, which similarly also applies to the connection device.

The carrier preferably has first coupling sections by means of which the connection device can be secured in the system interior. These can, for example, interact with corresponding second coupling sections on the profile rail element side by means of force fit or form fit.

The carrier can preferably have side legs that at least partially delimit a connection space. Preferably, the carrier can have two side legs, which are particularly preferably parallel to one another. The carrier can further preferably have a transverse leg that connects the side legs and further delimits the connection space. Thus, the carrier can be designed to be particularly stable and have an optimized geometry.

The connection terminal is preferably completely accommodated in the connection space in such a way that, on the one hand, it is securely positioned and protected during transportation and, on the other hand, can be safely stowed in a corresponding support rail upon installation of the carrier therein, for example.

The connection terminal can preferably be secured to one of the side legs or the transverse leg, if present. Thus, a simple structure for the connection device and also a stable connection for this unit are provided.

The carrier preferably has a substantially U-shaped cross section, which is particularly preferably formed by the side legs and further preferably the transverse leg. This simple structure also offers a stable design, wherein reference is also made to the previously described advantages of a corresponding U-shaped cross section of the carrier.

The connection device can also have at least two connection terminals of the type described above, wherein the connection terminals are preferably distributed over the two side legs and/or the transverse leg, if present. Thus, the number of connection terminals can be adapted as required, for example to the number of busbars provided in a support rail system.

The carrier can preferably be produced from an electrically conductive material. Preferably, the carrier is produced from sheet metal and/or as a stamped and bent part. Thus, the carrier offers the possibility of also establishing grounding contact in a simple manner, for example to a support rail of the support rail system.

The connection terminal can also have a physical grounding contact. This can preferably be electrically connected to the carrier when the connection terminal is secured to the carrier. In this manner, grounding of the connection terminal can be effected via the carrier by simply inserting the carrier and contacting the carrier with a corresponding component. In this manner, particularly secure grounding contact can be established.

The insulating material housing can preferably have securing structures that interact with corresponding securing structures of the carrier for securing the connection terminal to the carrier. The same advantages apply here as described above for the securing structures.

The connection terminal is particularly preferably releasably secured to the carrier in such a way that a carrier can be accordingly fitted with connection terminals as required, and such that these can also be replaced. Thus, the flexibility with regard to assembly and the variety of variants is thus particularly high.

### BRIEF DESCRIPTION OF THE DRAWINGS

Further features and advantages of the present invention are described hereinafter with reference to the figures of the accompanying drawings. In the figures:

FIG. 1 is a perspective view of a support rail system with a support profile rail element according to a first embodiment of the present invention,

FIG. 2 shows a detailed view of the support rail system or support profile rail element according to FIG. 1 viewed in the longitudinal direction of extension in direction II,

FIG. 3 is a partial perspective view of a support profile rail element according to a second embodiment of the present invention in a partially assembled state,

FIG. 4a is an exploded perspective view of a connection device according to a third embodiment of the present invention,

FIG. 4b is a detailed view of the connection device according to FIG. 4a in the assembled state viewed in the longitudinal direction of extension in direction IV,

FIG. 5 is a perspective view of a connection device according to a fourth embodiment of the present invention,

FIG. 6 is an end-face view of the connection device according to FIG. 5, viewed in direction VI,

FIG. 7 is a perspective view of the connection terminals of the connection device according to FIG. 5,

FIG. 8 is an end-face view of the connection terminals according to FIG. 7, viewed in direction VIII,

FIG. 9 is a schematic plan view of a portion of a support rail system according to a fifth exemplary embodiment of the present invention,

FIG. 10 is a schematic plan view of a portion of a support rail system according to a sixth embodiment of the present invention with two embodiment variants of a support profile rail element according to the invention,

FIG. 11 is a schematic plan view of a portion of a support rail system according to a seventh embodiment of the present invention with two embodiment variants of a support profile rail element according to the invention,

FIG. 12 is a schematic plan view of a portion of a support rail system according to an eighth embodiment of the present invention with two embodiment variants of a support profile rail element according to the invention, and

FIG. 13 is a schematic plan view of seven different application variants of a support rail system according to the present invention.

### DETAILED DESCRIPTION OF EXEMPLARY EMBODIMENTS

The drawings show different embodiments of a support profile rail element 1 for forming an elongated support rail system 100 along with different embodiment variants of a corresponding support rail system 100 according to the invention, and different embodiments of connection devices 10 according to the invention. The support profile rail element 1 is preferably a luminaire support rail profile element, the support rail system 100 is preferably a luminaire support rail system, and the connection device 10 is preferably a luminaire connection device.

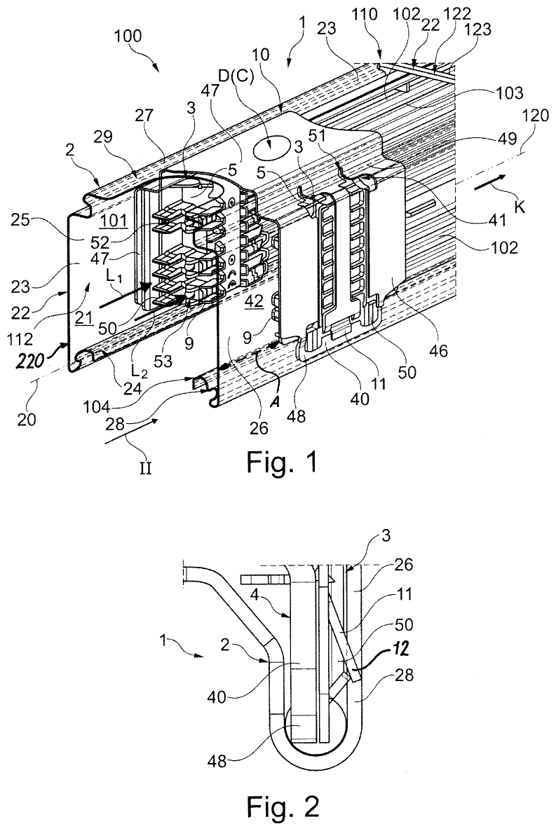

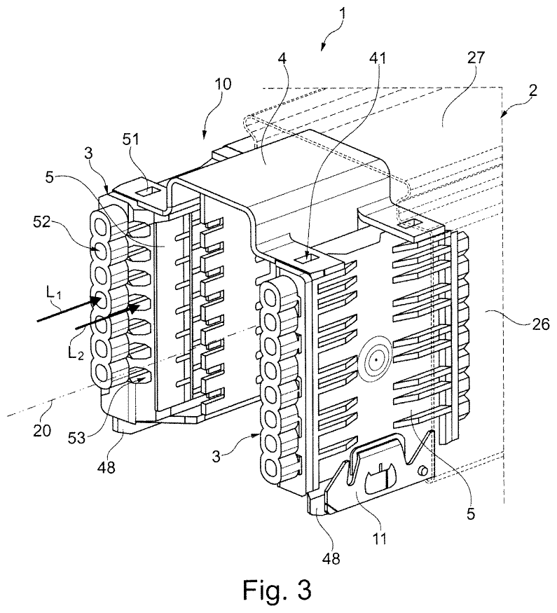

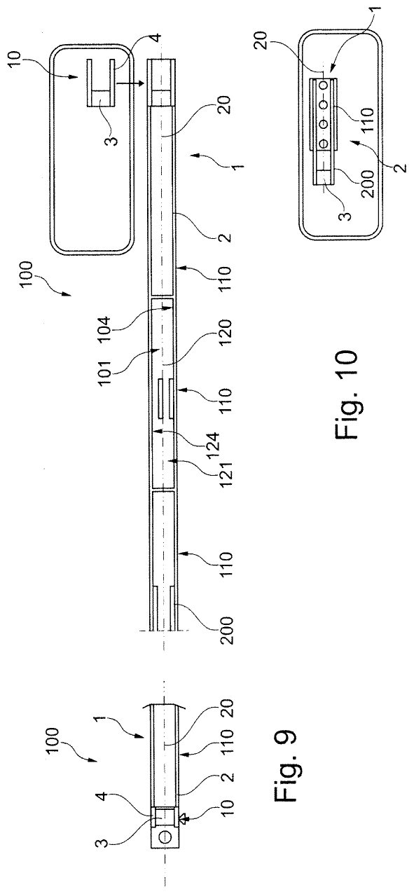

The support profile rail element 1 according to the invention is shown by way of example in FIGS. 1 and 3 and schematically in FIG. 9-12. The support profile rail element 1 is used to form an elongated support rail system 100, as shown, for example, in FIGS. 1 and 9-12. The elongated support rail system 100 has an elongated busbar 102 arranged in a system interior 101 of the support rail system 100 and extending longitudinally therein, which busbar comprises electrical conductors 103 extending longitudinally in parallel with one another for the electrical connection of electrical or electronic components via an elongated system coupling opening 104 of the support rail system 100.

On the one hand, the support profile rail element 1 has an elongated profile rail element 2 with a longitudinal extension 20. The profile rail element 2 delimits an interior 21 and has an elongated coupling opening 24, as can be seen in particular in FIG. 1. At at least one of its ends 22 opposite one another with respect to the longitudinal extension 20, the profile rail element 2 has a connection section 23 for connecting to a corresponding further connection section 113 of an elongated support profile rail 110 to form the support rail system 100. This is shown by way of example in FIG. 1.

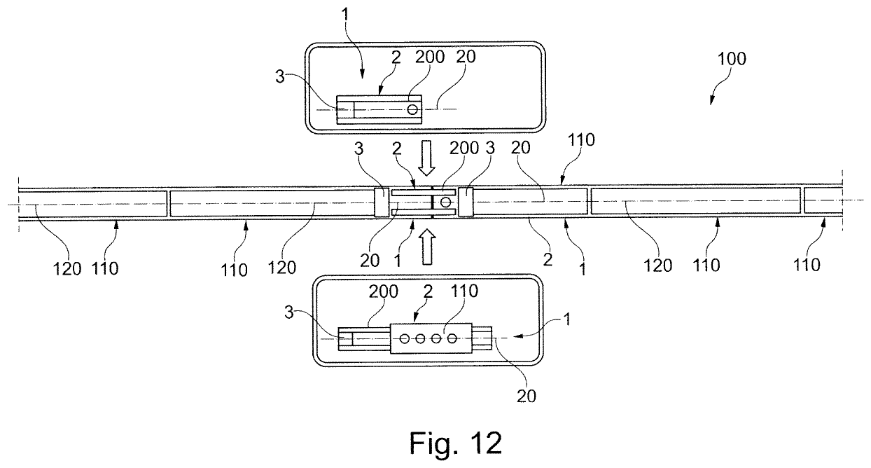

The profile rail element 2 can, for example, simply be designed as a support profile rail of a corresponding support rail system 100, as shown in FIGS. 1, 10 and 11. However, it is also conceivable that the profile rail element 2 is designed, for example, as a connector for connecting a plurality of support profile rails 110 (cf, for example, FIG. 12, upper embodiment variant). It is also conceivable that the profile rail element 2 is designed as a combination of a support profile rail and connector, which collectively form the interior 21 (cf., for example, FIG. 12, lower embodiment variant).

The profile rail element 2 preferably has a substantially U-shaped cross section when viewed in the direction of the longitudinal extension 20, as can be seen in FIGS. 1 and 3, for example. As can also be seen there, the profile rail element 2 preferably has two substantially parallel side wall legs 25, 26, which laterally delimit the coupling opening 24. The profile rail element 2 here preferably also has a transverse wall leg 27 connecting the side wall legs 25, 26 in such a way that the U-shape of the profile rail element 2 described above arises.

The support profile rail element 1 also has a connection terminal 3, which is completely accommodated and secured in the interior 21, as can be seen in FIG. 1, for example. The connection terminal 3 can, for example, be secured adjacent to one of the two side wall legs 25, 26 and/or the transverse wall leg 27—here, in each case to one of the two side wall legs 25, 26: here in particular secured to the corresponding leg 25, 26 itself. This can more preferably be done by means of a carrier 4 described below. The connection terminal 3 is preferably provided close to the longitudinal end face 220 of the at least one end 22: preferably, the connection terminal 3 is secured at a defined distance A—consequently along (the direction of) the longitudinal extension 20—to the associated longitudinal end face 220 of the profile rail element 2, so as to be completely accommodated in the interior 21 thereof. The defined distance A is preferably between 40-100 mm, although the invention is not limited to this.

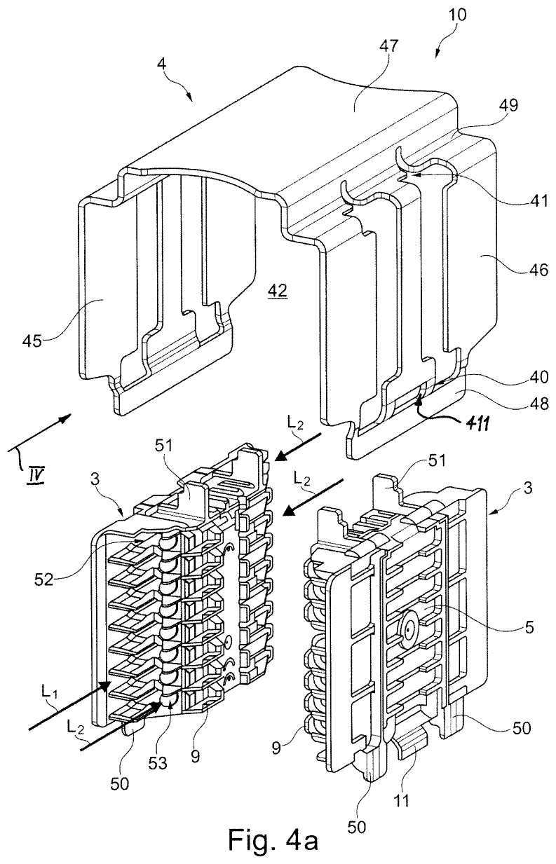

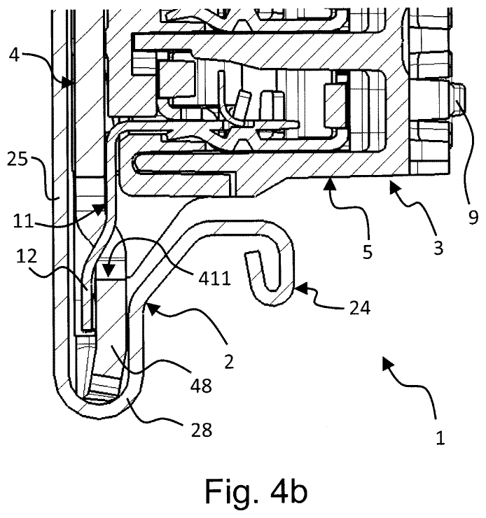

Such a carrier 4 is shown, for example, in FIG. 1-6. As can be clearly seen in FIGS. 1 and 3-6, for example, the carrier 4 supports the connection terminal 3 or, as shown in the embodiments, the connection terminals 3, in this case, two connection terminals. Unless otherwise indicated, the general reference to FIG. 4 refers to both FIGS. 4a and 4b.

The carrier 4 in turn has first coupling sections 48, 49, which are designed to interact with second coupling sections 28, 29 of the profile rail element 2—or here, the respective side wall legs 25, 26—for securing the carrier 4 together with the connection terminals 3 in the interior 21.

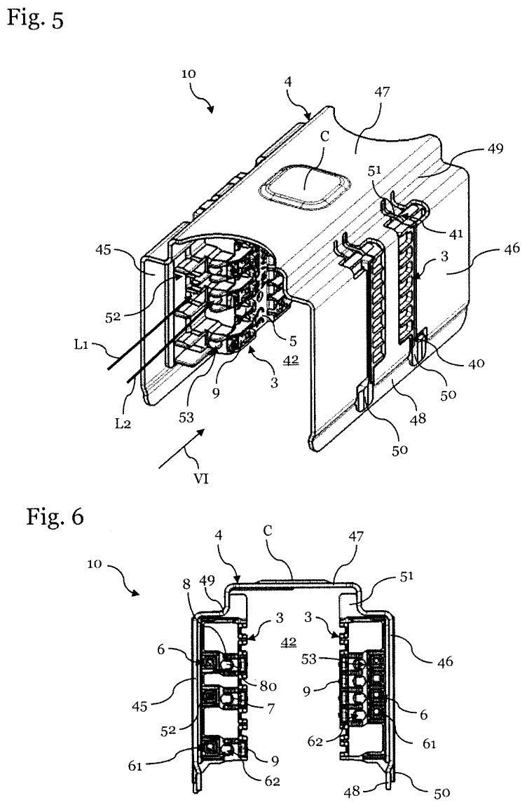

The carrier 4 can be releasably or non-releasably connected to the profile rail element 2. A releasable connection could, for example, be a force fit, such as by clamping. Such clamping can be seen by way of example in the detailed representations of FIGS. 2 and 4b, where the carrier 4 engages here by its coupling section 48, 49 in a corresponding recess in order to form the corresponding second coupling section 28, 29 of the side wall leg 26. Furthermore, the connection can be made by means of a form fit, for example by snapping or clinching (see reference sign D in FIG. 1 and the corresponding region C raised for clinching in FIG. 5) or riveting or screwing, and the like. A connection by means of a material fit, such as welding or soldering, is also conceivable.

The carrier 4 can preferably have side legs 45, 46, which at least partially delimit a connection space 42. This can be seen for example in FIGS. 5 and 6. The carrier 4 can preferably have two side legs 45, 46, which are parallel to one another here, for example, as can be seen in particular in FIG. 6. Furthermore, the carrier 4 shown here preferably has a transverse leg 47 connecting the side legs 45, 46 and further delimiting the connection space 42.

The connection terminal 3 has an insulating material housing 5, as can be seen in FIGS. 1 and 3-8, for example. The insulating material housing 5 preferably has securing structures 50, 51, which are designed to interact with corresponding securing structures of the profile rail element 2 and/or, as shown here, with corresponding securing structures 40, 41 of the carrier 4 for securing the connection terminal 3 thereto. This can be seen, for example, from looking at FIG. 4-6 as a whole. The connection terminals 3 are formed here, for example, having securing structures 50, 51 in the insulating material housing 5 in the form of projections. These can be snapped into corresponding punched recesses as corresponding securing structures 40, 41 of the carrier 4 here in order to safely secure the connection terminal 3 in the carrier 4: this preferably being releasable here.

The connection terminal 3 is preferably completely accommodated in the connection space 42 here, as can be seen in particular in FIG. 6 and can equally be seen here for both connection terminals 3. The connection terminals 3 are each secured directly to one of the two side legs 45, 46 here: this is done by means of the previously described securing structures 50, 51 of the insulating material housing 5 via the corresponding securing structures 40, 41 of the side legs 45, 46 of the carrier 4.

As can be seen in particular from FIG. 4-6, the carrier 4 preferably has a substantially U-shaped cross section. This is preferably formed by the side legs 45, 46 and further preferably the transverse leg 47, as shown in FIG. 6, for example.

As can be seen in particular from FIGS. 1 and 3-6, the two connection terminals 3 shown here by way of example can preferably be distributed on the given legs-here, the two side legs 45, 46.

Particularly preferably, the carrier 4 can have a cross-sectional contour that follows a cross-sectional contour of the profile rail element 2, at least in regions, as can be seen in particular in FIGS. 1 and 3.

The carrier 4 can preferably be produced from an electrically conductive material. For example, the carrier 4 can be produced from sheet metal and/or as a stamped and bent part. This can be seen in FIG. 4a, for example. In addition, the profile rail element 2 can also be produced from sheet metal and/or produced as a stamped and bent part, as can be seen in FIGS. 1 and 3, for example.

The connection terminal 3 also has a plurality of spring force clamping connections 6, each of which is at least partially accommodated in the insulating material housing 5, as can be seen in particular in FIGS. 1 and 3 to 8. Each of the spring force clamping connections 6 in turn has a first conductor clamping point 61 for direct mechanical and electrical coupling of at least one electrical conductor 103 in a first conductor connection direction L1. The first conductor clamping points 61 can preferably each be designed for selective and preferably tool-free connection and release of electrical conductors 103. Examples of preferably tool-free actuation shall be described below. The electrical conductors 103 are preferably those of the busbar 102.

Furthermore, each spring force clamping connection 6 has a second conductor clamping point 62-64, which is electrically connected to the first conductor clamping point 61 of the same spring force clamping connection 6; this is for direct mechanical and electrical coupling of at least one external electrical conductor 103 in a second conductor connection direction L2 for electrical connection of the support profile rail element 1, as shown by way of example in FIG. 1. The second conductor clamping points 62-64 can also each be designed for the selective and preferably tool-free connection and release of (external) electrical conductors.

As can be seen in particular from FIGS. 1, 4, 5 and 7, each spring force clamping connection 6 can also have a plurality of second conductor clamping points 62-64, which are then accordingly electrically connected to one another and to the first conductor clamping point 61 of the same spring force clamping connection 6. Thus, the connection terminal 3 can be electrically contacted with external electrical conductors from different sides (here, for example, from the front and rear), which increases the flexibility of the connection options.

In the embodiments shown here, the second conductor connection directions L2 are all parallel to one another and preferably also parallel to the longitudinal extension 20 here, as can be seen in FIG. 1, for example. The second conductor connection directions L2 are preferably arranged in at least one or more rows next to one another. In particular in the design of the embodiments comprising a plurality of second conductor clamping points 62-64, grouping of the second conductor clamping points 62-64 is suitable here, wherein each grouping (for example: first group=all second conductor clamping points 62: second group=all second conductor clamping points 63: third group=all second conductor clamping points 64) preferably has second conductor connection directions L2 arranged next to one another in a row. This ensures a particularly compact design and simple electrical connection of electrical conductors at the second conductor clamping points 62-64.

All of the first conductor connection directions L1 for each connection terminal 3 are parallel to one another. The connection terminal 3 is also arranged relative to the connection section 23 such that, when the support profile rail element 1 is connected to a support profile rail 110, which has an elongated busbar 102 extending longitudinally therein, via its further connection section 123, all of the likewise parallel electric conductors—here, for example, the electrical conductors 103 of the corresponding busbar 102—are simultaneously directly mechanically and electrically coupled to the respective first conductor clamping points 61 during a coupling movement K of the support profile rail element 1 or at least of the connection terminal 3 secured in the interior 21 that is parallel to the first conductor connection directions L1.

The first conductor connection directions L1 are preferably all parallel to the longitudinal extension 20 in such a way that particularly simple assembly and coupling of the connection terminal 3 with a corresponding busbar 102 is possible. As can be seen in particular from FIGS. 1 and 3 to 8, all of the first conductor connection directions L1 are preferably arranged in a row next to one another.

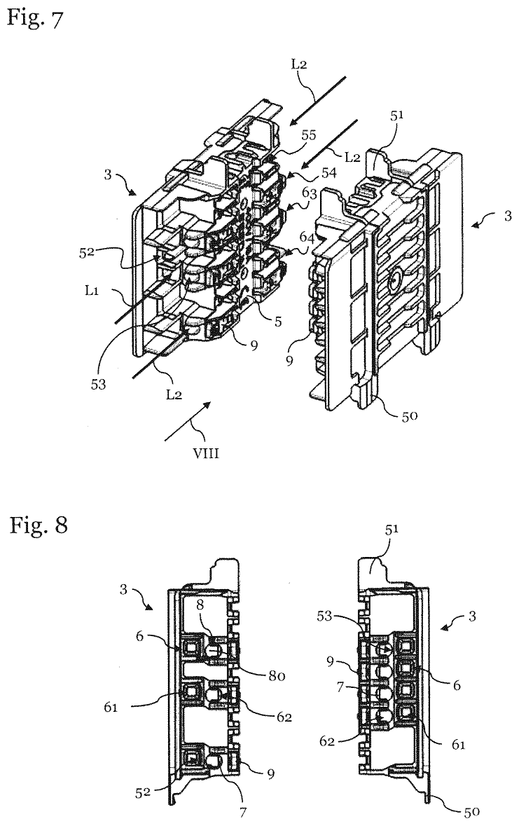

As indicated in FIG. 7, for example, the first conductor connection direction L1 and the or one of the second conductor connection direction(s) L2 can be aligned coaxially with one another for each spring force clamping connection 6 and preferably also directed toward one another here, for example. As also indicated in FIG. 4a, the first conductor connection direction L1 and the or, in this case, one of the second conductor connection directions L2 can also be radially offset from one another for each spring force clamping connection 6. This offset is preferably provided in such a way that the first conductor clamping point 61 is closer to the profile rail element than the second conductor clamping point 62 assigned to the corresponding second conductor connection direction L2 when the connection terminal 3 is secured in the interior 21 (cf., for example, FIG. 1).

As can be seen in particular from FIG. 7, the first conductor clamping point 61 and the or—as shown here—at least one of the second conductor clamping points 63, 64 can be accessible from opposite sides of the terminal 3 for each spring force clamping connection 6.

As can be seen in FIGS. 1 and 3 to 8, the insulating material housing 5 has a conductor insertion channel 52-55 for each conductor clamping point 61-64. These extend from the outside to the assigned conductor clamping point 61-64. It is preferable if the conductor insertion channels 52-55 taper, at least in portions, toward the corresponding conductor clamping point 61-64 and thus form, for example, a type of insertion funnel. This facilitates the insertion of a corresponding electrical conductor to the respective conductor clamping points 61-64.

Each spring force clamping connection 6 can preferably have a contact element 7 (for example, a so-called busbar) and at least one clamping spring 8 with at least one movable clamping leg 80, as shown by way of example in FIGS. 6 and 8. The clamping leg 80 can be movable between a clamping position (cf. FIGS. 6 and 8), in which the clamping leg 80 presses against a contact portion of the contact element 7 to form the first or second conductor clamping point 61-64, and an insertion position, in which this conductor clamping point 61-64 is open for the insertion of an electrical conductor 103. The clamping spring 8 can be mounted in the contact element 7 and/or the insulating material housing 5. For example, the clamping spring 8 can have a support leg (not shown) at its end applied to the clamping leg 80 for positioning the clamping spring 8. Alternatively, the end of the clamping spring 8 facing away from the clamping leg 80 can also be provided as a (second) clamping leg with similar functionality to the clamping leg 80 for another conductor clamping point 61-64.

Each spring force clamping connection 6 can have at least one release element 9 for the selective tool-free opening of at least one of the conductor clamping points (here, the two second conductor clamping points 62, 63). The release element 9 can, for example, be designed as a pusher or, as shown here, as a swivel lever or have such a pusher or swivel lever. The release element 9 is preferably (rotationally and/or translationally) movably mounted in the insulating material housing 5. In the embodiment shown, for example, the swivel lever 9 shown here is mounted in the insulating material housing 5 so that it can rotate about an axis of rotation.

As shown in the preferred embodiment illustrated, the release element 9 preferably interacts with the clamping leg 80 in such a way as to selectively move the clamping leg 80 from the clamping position to the insertion position.

As can be seen in FIGS. 1 to 4, for example, the connection terminal 3 can have a grounding contact 11. This is preferably provided in such a way that the grounding contact 11 is electrically connected to the profile rail element 2 when the connection terminal 3 is secured in the interior 21; preferably via the carrier 4. Consequently, in the latter case, the grounding contact 11 can be electrically connected to the carrier 4 when the connection terminal 3 is secured to the carrier 4. This is shown by way of example in FIG. 4b. Here, the grounding contact 11 is preferably electrically connected to at least one of the spring force clamping connections 6 or the contact element 7 thereof: for example, by means of a direct mechanical connection, for example by means of a plug-in or snap-in connection or by being integrally formed therewith. The grounding contact 11 can, for example, be designed as a grounding lug 12 and thus protrude outward from the connection terminal 3 for electrical coupling. The grounding contact 11 or its grounding lug 12 can be guided through a grounding opening 411 in the carrier 4—for example in a meandering fashion—and thus be in contact with the carrier 4 (electrically and preferably also mechanically), as shown by way of example in the sectional view in FIG. 4b. Due to the preferred connection of the connection terminal 3 or the carrier 4 to the profile rail element 2, the electrical connection of the connection terminal 3 to the profile rail element 2 via the grounding contact 11 is in turn provided. In the embodiment of FIG. 2, a distal end or the grounding lug 12 of the grounding contact 11 protrudes as a contact spring element in such a way that, when the first coupling section 48 of the carrier 4 is accommodated in the second coupling section 28 of the profile rail element 2, said contact spring element is clamped or fixed between the carrier 4 (or its first coupling section 48) on the one hand and the profile rail element 2 (or its second coupling section 28) on the other hand, in order to provide a secure electrical contact between the connection terminal 3 and the profile rail element 2 via the grounding contact 11. To illustrate the clamping contact, the grounding lug or contact spring element 12 is shown in FIG. 2 in the unfixed state.

As already mentioned, the support profile rail element 1 can have at least two of the connection terminals 3, which, as can be seen in particular from FIGS. 1 and 3 to 6, are then preferably distributed over the two opposite sides in relation to the coupling opening 24 and/or on a (rear) side opposite the coupling opening 24. The connection terminal(s) is/are preferably releasably secured as described above.

The combination of the carrier 4 and connection terminal 3 can form a connection device 10, shown here by way of example in FIGS. 4 to 6, which forms an independent part of the present invention. The connection device 10 is designed for a support rail system 100 with an elongated busbar 102 arranged in a system interior 101 of the support rail system 100 and extending longitudinally therein, which busbar comprises conductors 103 extending longitudinally and in parallel with one another for the electrical connection of electrical or electronic components via an elongated system coupling opening 104 of the support rail system 100.

As already described above, the connection device 10 comprises the carrier 4, which is designed in such a way that it can be completely inserted into the system interior 101 of the support rail system 100 via the system coupling opening 104 and secured therein, as indicated, for example, in FIG. 3. The connection terminal 3 has already been described; therefore, reference is made in full to the above description at this point, which applies similarly. Thus, the connection terminal 3 also comprising the insulating material housing 5 for the connection device 10 and the plurality of spring force clamping connections 6, each of which is at least partially or completely accommodated in the insulating material housing 5. Each of the spring force clamping connections 6 comprises the first conductor clamping point 61 for direct mechanical and electrical coupling of at least one electrical conductor (preferably the electrical conductor 103 of the busbar 102) in the first conductor connection direction L1. The spring force clamping connection 6 also comprises the second conductor clamping point (or the second conductor clamping points) 62-64, which is/are electrically connected to the first conductor clamping point 61 of the same spring force clamping connection 6. The second conductor clamping points 62-64 are also used for directly mechanically and electrically coupling at least one external electrical conductor in the second conductor connection direction L2 for the electrical connection of the connection device 10. All of the first conductor connection directions L1 are also parallel to one another in order to simultaneously directly mechanically and electrically couple all electrical conductors 103 of the corresponding busbar 102 shown here, which conductors are also parallel to one another, to the corresponding first conductor clamping points 61 during a coupling movement K that is parallel to the first conductor connection directions L1. The connection terminal 3 is secured to the carrier 4 in such a way that it can be handled as a single unit. The connection device 10 can of course also have a plurality of connection terminals 3, two here for example, which can preferably be distributed over the two side legs 45, 46 and further preferably can alternatively or additionally be distributed over the transverse leg 47.

With reference to FIGS. 1 and 9 to 12, possible embodiments of support rail systems 100 with the support profile rail element 1 or the connection device 10 according to the invention will now be described.

The support rail system 100 according to the present invention has, on the one hand, at least one support profile rail element 1 according to one of the preceding claims. Furthermore, the support rail system 100 also has at least one support profile rail 110, which has a further longitudinal extension 120. The support profile rail 110 further delimits a further interior 121 and has a further elongated coupling opening 124. The support profile rail 110 has, at at least one of its ends 122 opposite one another with respect to the further longitudinal extension 120 or at both opposite ends 122, a further connection section 123 for connecting to the connection section 23 of the profile rail element 2 (or also for connecting further connection sections 123 of further support profile rails 110) to form the support rail system 100, in such a way that their interiors 21, 121 form a common system interior 101 and their coupling openings 24, 124 form a common system coupling opening 104 (cf. FIGS. 1 and 9 to 12).

Furthermore, as shown by way of example in FIG. 1, the support rail system 100 also has an elongated busbar 102, which extends longitudinally in the system interior 101. The busbar 102 has electrical conductors 103 extending longitudinally in parallel with one another for the electrical connection of electrical or electronic components via the system coupling opening 104. Each of the electrical conductors 103 of the busbar 102 is preferably directly mechanically and electrically coupled at the end face to one of the first conductor clamping points 61 of the connection terminal 3 through a coupling movement K of the connection terminal 3 or the associated support profile rail element 1 relative to the busbar 102 and in parallel with the first conductor connection directions L1 or the longitudinal extension 20, 120. This can be seen, for example, in FIG. 1.

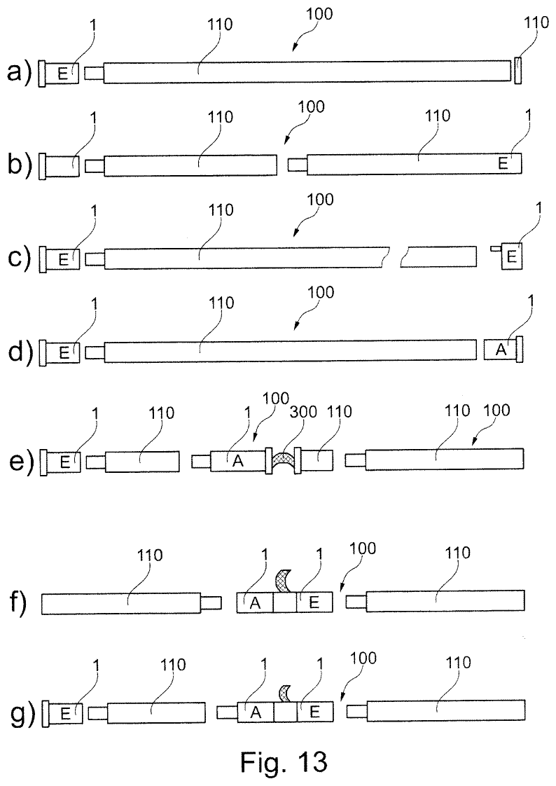

The support profile rail element 1 can, for example, be designed as an end piece of the support rail system 100, as shown in FIGS. 1, 9, 10 and 13A-C, for example. It is also conceivable that the support profile rail element 1 is designed as a center piece for insertion between two further support profile rails 110, as shown, for example, in FIGS. 12 and 13F-G.

The busbar 102 can be arranged on an inner wall 112 of the support profile rail 110, as can be seen in FIG. 1, for example. Likewise—at least in the assembled state of the support rail system 100—the busbar 102 can alternatively or additionally be arranged on an inner wall of the profile rail element 2 and here of the corresponding side wall leg 25, 26, as can also be seen, for example, in FIG. 1.

With reference to FIGS. 9 to 13, some application examples of the support profile rail element 1 within the framework of a support rail system 100 are shown. FIG. 9 shows, for example, a support profile rail element 1 with a profile rail element 2 in the form of a support rail 110 for feeding into a support rail system 100, as also shown schematically in FIG. 13A-C and also shown in FIG. 1. FIG. 10 shows the provision for feeding out. For example, the support profile rail element 1 can be formed here by a connector 200 along with a support profile rail 110 (lower embodiment variant). In the upper embodiment variant of FIG. 10, the provision of the connection terminal 3 via the connection device 10 according to the invention as a retrofit component is shown by way of example. The feed-out is also shown by way of example in FIG. 13D as a final end piece and in FIG. 13E, for example, as an end piece with a flexible transition 300 to a further support rail system 100.

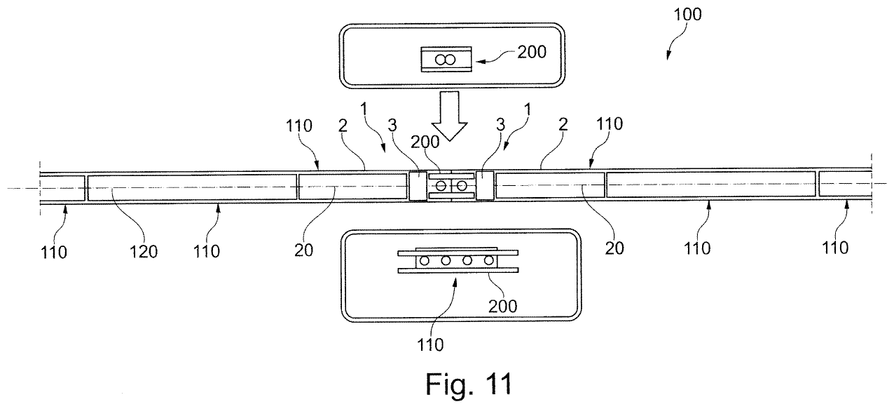

FIG. 11 shows two support profile rail elements 1 provided as a center piece for feeding in, which are coupled here, for example, via a connector 200 (upper of the two embodiment variants) or via a support rail 110 formed as a spacer (lower of the two embodiment variants) with corresponding connectors 200 to form an entire support rail system 100. This basically corresponds to the representation in FIG. 13F, wherein in the embodiment of FIG. 13F, the two connection terminals 3 are part of the center piece, which is formed as the support profile rail element 1.

FIG. 12 shows by way of example the provision of a support profile rail element 1 as a center piece for insertion into a support rail system 100, wherein the profile rail element 2 can be designed here, as shown in the lower embodiment variant, as a support rail 110 with a connector 200 or, as shown in the upper embodiment variant, purely as a connector 200. The left of the two support profile rail elements 1 or connection terminals 3 is used by way of example for feeding out, while the right one is used here, for example, for feeding in. The lower of the two embodiment variants in FIG. 12 is similarly also shown schematically in FIG. 13G, wherein the right connection terminal 3 is also part of the support profile rail element 1.

The support rail system 100 can further have an electrical or electronic component. This then preferably has a functional section and a connection section electrically connected to the functional section. The connection section is used for electrical connection to the busbar 102 via the system coupling opening 114. The functional section can, for example, have a luminaire (for example, a strip light to form a light band or a spot light), a sensor, a loudspeaker, or the like. The components preferably cover the entire system coupling opening 104. Regions not covered by electrical or electronic components can also be covered with screens if required.

The present invention is not limited by the embodiments described above, provided it is covered by the subject matter of the present claims. In particular, the features of the embodiments can be combined and interchanged and replaced in any way.

1. A support profile rail element (1) for forming an elongated support rail system (100) with an elongated busbar (102) arranged in a system interior (101) of the support rail system (100) and extending longitudinally therein, said busbar comprising electrical conductors (103) extending longitudinally in parallel with one another for the electrical connection of electrical or electronic components via an elongated system coupling opening (104) of the support rail system (100), wherein the support profile rail element (1) has:
an elongated profile rail element (2) with a longitudinal extension (20), which delimits an interior (21) and has an elongated coupling opening (24), wherein the profile rail element (2) has, at at least one of its ends (22) opposite one another with respect to the longitudinal extension (20), a connection section (23) for connecting to a corresponding further connection section (123) of an elongated support profile rail (110) in order to form a support rail system (100), and
a connection terminal (3), which is completely accommodated and fastened in the interior (21), wherein the connection terminal (3) has:
an insulating material housing (5), and
a plurality of spring force clamping connections (6), which are at least partially accommodated in the insulating material housing (5), wherein each spring force clamping connection (6) has:
a first conductor clamping point (61) for direct mechanical and electrical coupling of at least one electrical conductor (103) in a first conductor connection direction (L1), and
a second conductor clamping point (62-64), which is electrically connected to the first conductor clamping point (61) of the same spring force clamping connection (6), for direct mechanical and electrical coupling of at least one external electrical conductor in a second conductor connection direction (L2) for electrical connection of the support profile rail element (1),
wherein all of the first conductor connection directions (L1) are parallel to one another, and the connection terminal (3) is arranged relative to the connection section (23) such that, when the support profile rail element (1) is connected to a support profile rail (110), which has an elongated busbar (102) extending longitudinally therein, via its further connection section (123), all of the likewise parallel electric conductors (103) of the corresponding busbar (102) are simultaneously mechanically and electrically directly coupled to the corresponding first conductor clamping points (61) during a coupling movement (K) of the support profile rail element (1) or at least of the connection terminal (3) secured in the interior (21), which coupling movement is parallel to the first conductor connection directions (L1).

2. The support profile rail element (1) according to claim 1, at least having two connection terminals (3), which are distributed over the two opposite sides in relation to the coupling opening (24) and/or on a side opposite the coupling opening (24), and/or
wherein the connection terminal(s) (3) is/are releasably secured.

3. The support profile rail element (1) according to claim 1, wherein the first conductor clamping points (61) are each designed for the selective, preferably tool-free, connection and release of electrical conductors (103), and/or
wherein the second conductor clamping points (62-64) are each designed for the selective, tool-free, connection and release of electrical conductors (103).

4. The support profile rail element (1) according to claim 1, wherein each spring force clamping connection (6) has a contact element (7) and at least one clamping spring (8) with at least one movable clamping leg (80), wherein the clamping leg (80) is movable between a clamping position, in which the clamping leg (80) presses against a contact portion of the contact element (7) to form the first or second conductor clamping point (61, 62-64), and an insertion position, in which this conductor clamping point (61, 62-64) is open for the insertion of an electrical conductor.

5. The support profile rail element (1) according to claim 1, wherein each spring force clamping connection (6) has at least one release element (9) for the selective tool-free opening of at least one of the conductor clamping points (62, 63), wherein the release element (9) preferably has a pusher or a swivel lever, and wherein the release element (9) is preferably movably mounted in the insulating material housing (5).

6. The support profile rail element (1) according to claim 4, wherein the release element (9) interacts with the clamping leg (80) in such a way as to selectively move the clamping leg (80) from the clamping position into the insertion position.

7. The support profile rail element (1) according to claim 1, wherein each spring force clamping connection (6) has a plurality of second conductor clamping points (62-64), which are electrically connected to one another and to the first conductor clamping point (61) of the same spring force clamping connection (6).

8. The support profile rail element (1) according to claim 1, wherein the first conductor connection directions (L1) are all parallel to the longitudinal extension (20), and/or
wherein all of the first conductor connection directions (L1) are arranged next to one another in a row.

9. The support profile rail element (1) according claim 1, wherein all second conductor connection directions (L2) are parallel to one another and preferably also parallel to the longitudinal extension (20), and/or
wherein the second conductor connection directions (L2) are arranged next to one another in at least one or more rows.

10. The support profile rail element (1) according to claim 1, wherein the first conductor connection direction (L1) and the or one of the second conductor connection directions (L2) are aligned coaxially with one another and preferably directed toward one another for each spring force clamping connection (6), and/or
wherein the first conductor connection direction (L1) and the or one of the second conductor connection directions (L2) are radially offset relative to one another for each spring force clamping connection (6), preferably in such a way that the first conductor clamping point (61) is closer to the profile rail element (2) than the second conductor clamping point (62) assigned to the second conductor connection direction (L2) when the connection terminal (3) is secured in the interior (21).

11. The support profile rail element (1) according to claim 1, wherein, for each spring force clamping connection (6), the first conductor clamping point (61) and the or at least one of the second conductor clamping points (63, 64) are accessible from opposite sides of the connection terminal (3).

12. The support profile rail element (1) according to claim 1, wherein the insulating material housing (5) has a conductor insertion channel (52-55) for each conductor clamping point (61-64), which channel extends from the outside toward the associated conductor clamping point (61-64) and tapers, at least in portions, toward the conductor clamping point (61-64).

13. The support profile rail element (1) according to claim 1, wherein the profile rail element (2) is produced from sheet metal and/or is produced as a stamped and bent part.

14. The support profile rail element (1) according to claim 1, further having a carrier (4) that supports the connection terminal(s) (3),
wherein the carrier (4) has first coupling sections (48, 49) that are designed to interact with second coupling sections (28, 29) of the profile rail element (2) for securing the carrier (4) together with the connection terminal (3) or connection terminals (3) in the interior (21).

15. The support profile rail element (1) according to claim 14, wherein the carrier (4) has a substantially U-shaped cross section, and/or
wherein the carrier (4) has a cross-sectional contour that follows a cross-sectional contour of the profile rail element (2), at least in portions.

16. The support profile rail element (1) according to claim 14, wherein the carrier (4) is produced from an electrically conductive material, comprising sheet metal and/or as a stamped and bent part.

17. The support profile rail element (1) according to claim 14, wherein the carrier (4) is releasably or non-releasably connected to the profile rail element (2).

18. The support profile rail element (1) according to claim 1, wherein the connection terminal (3) has a grounding contact (11), which is provided in such a way that the grounding contact (11) is electrically connected to the profile rail element (2), via the carrier (4), if present, when the connection terminal (3) is secured in the interior (21).

19. The support profile rail element (1) according to claim 1, wherein the insulating material housing (5) has securing structures (50, 51), which are designed to interact with corresponding securing structures of the profile rail element (2) and/or, if present, with corresponding securing structures (40, 41) of the carrier (4) for securing the connection terminal (3) thereto.

20. The support profile rail element (1) according to claim 1, wherein the profile rail element (2) is a support profile rail (110), a connector for connecting a plurality of support profile rails (110), or a combination of a support profile rail (110) and connector, which collectively form the interior (21).

21. The support profile rail element (1) according to claim 1, wherein the profile rail element (2) has a substantially U-shaped cross section when viewed in the direction of the longitudinal extension (20).

22. The support profile rail element (1) according to claim 1, wherein the profile rail element (2) has two substantially parallel side wall legs (25, 26), which laterally delimit the coupling opening (24),
wherein the profile rail element (2) preferably also has a transverse wall leg (27) connecting the side wall legs (25, 26).

23. The support profile rail element (1) according to claim 22, wherein the connection terminal (3) is secured adjacently to one of the two side wall legs (25, 26) and/or the transverse wall leg (27), if present, to the corresponding leg and further by means of the carrier (4), if present.

24. A support rail system (100), having
at least one support profile rail element (1) according to claim 1,
a support profile rail (110) with a further longitudinal extension (120), which delimits a further interior (121) and has a further elongated coupling opening (124), wherein, at at least one of its ends (122) opposite one another with respect to the further longitudinal extension (120), the support profile rail (110) has a further connection section (123) for connecting to the connection section (23) of the profile rail element (2) in order to form the support rail system (100) such that their interiors (21, 122) form a common system interior (101) and their coupling openings (24, 124) form a common system coupling opening (104), and
an elongated busbar (102), which extends longitudinally within the system interior (101), wherein the busbar (102) has electrical conductors (103) extending longitudinally in parallel with one another for the electrical connection of electrical or electronic components via the system coupling opening (104),
wherein each of the electrical conductors of the busbar (102) is directly mechanically and electrically coupled at the end face to one of the first conductor clamping points (61) of the connection terminal (3) through a coupling movement (K) of the connection terminal (3) relative to the busbar (102), which movement is parallel to the first conductor connection directions (L1).

25. The support rail system (100) according to claim 24, wherein the support profile rail element (1) is designed as an end piece of the support rail system (100) or a center piece for insertion between two further support profile rails (110).

26. The support rail system (100) according to claim 24, wherein the busbar (102) is arranged on an inner wall (112) of the support profile rail (110) and/or the profile rail element (2).

27. The support rail system (100) according to claim 24, further having an electrical or electronic component, having:
a functional section, and
a connection section electrically connected to the functional section for electrical connection to the busbar (102) via the system coupling opening (104).

28. The support rail system (100) according to claim 27, wherein the functional section has a luminaire, a sensor, and/or a loudspeaker.

29. A connection device (10) for a support rail system (100) having an elongated busbar (102) arranged in a system interior (101) of the support rail system (100) and extending longitudinally therein, said busbar comprising electrical conductors (103) extending longitudinally in parallel with one another for the electrical connection of electrical or electronic components via an elongated system coupling opening (104) of the support rail system (100), wherein the connection device (10) has:
a carrier (4) which is designed to be completely inserted into the system interior (101) of the support rail system (100) via the system coupling opening (104) and to be secured therein, and
a connection terminal (3), which has:
an insulating material housing (5), and
a plurality of spring force clamping connections (6), which are at least partially accommodated in the insulating material housing (5), wherein each spring force clamping connection (6) has:
a first conductor clamping point (61) for direct mechanical and electrical coupling of at least one electrical conductor (103) in a first conductor connection direction (L1), and
a second conductor clamping point (62-64), which is electrically connected to the first conductor clamping point (61) of the same spring force clamping connection (6), for direct mechanical and electrical coupling of at least one external electrical conductor in a second conductor connection direction (L2) for the electrical connection of the connection device (10),
wherein all of the first conductor connection directions (L1) are parallel to one another in order to simultaneously directly mechanically and electrically couple all electrical conductors (103), which are also parallel to one another, of a corresponding busbar (102) to the corresponding first conductor clamping points (61) during a coupling movement (K) parallel to the first conductor connection directions (L1),
wherein the connection terminal (3) is secured to the carrier (4) in such a way that it can be handled as one unit.

30. The connection device (10) according to claim 29, wherein the carrier (4) has first coupling sections (48, 49) by means of which the connection device (10) can be secured in the system interior (101).

31. The connection device (10) according to claim 29, wherein the carrier (4) has side legs (45, 46) that at least partially delimit a connection space (42),
wherein the carrier (4) preferably has two side legs (45, 46), which are parallel to one another,
wherein the carrier (4) preferably also has a transverse leg (47) that connects the side legs (45, 46) and further delimits the connection space (42).

32. The connection device (10) according to claim 31, wherein the connection terminal (3) is completely accommodated in the connection space (42), and/or
wherein the connection terminal (3) is secured to one of the side legs (45, 46) or the transverse leg (47), if present.

33. The connection device (10) according to claim 29, wherein the carrier (4) has a substantially U-shaped cross section, preferably formed by the side legs (45, 46) and further the transverse leg (47).

34. The connection device (10) according to claim 29, further having at least two connection terminals (3), wherein the connection terminals (3) are preferably distributed over the two side legs (45, 46) and/or the transverse leg (47), if present.

35. The connection device (10) according to claim 29, wherein the carrier (4) is produced from an electrically conductive material.

36. The connection device (10) according to claim 29, wherein the connection terminal (3) has a grounding contact (11) which is electrically connected to the carrier (4) when the connection terminal (3) is secured to the carrier (4).

37. The connection device (10) according to claim 29, wherein the insulating material housing (5) has securing structures (50, 51) that interact with corresponding securing structures (40, 41) of the carrier (4) for securing the connection terminal (3) to the carrier (4), and/or
wherein the connection terminal (3) is releasably secured to the carrier (4).
